(19) United States
(12) Patent Application Publication
(10) Pub. No.: US 2024/0298708 A1
(43) Pub. Date: Sep. 12, 2024

(54) AEROSOL GENERATION SYSTEM

(71) Applicant: Japan Tobacco Inc., Tokyo (JP)

(72) Inventors: Mitsuhiro NAKATANI, Tokyo (JP); Manabu YAMADA, Tokyo (JP)

(73) Assignee: Japan Tobacco Inc., Tokyo (JP)

(21) Appl. No.: 18/666,861

(22) Filed: May 17, 2024

Related U.S. Application Data
(63) Continuation of application No. PCT/JP2021/042287, filed on Nov. 17, 2021.

(51) Int. Cl. A24F 40/465; A24D 1/20; A24F 40/20; H05B 6/10

(52) U.S. Cl. CPC A24F 40/465; A24D 1/20; A24F 40/20; H05B 6/105

(57) ABSTRACT

An aerosol generation system includes: a stick including an aerosol source and a susceptor; and an aerosol generation device. A cavity into which the stick is configured to be inserted and extracted through an opening is formed in the aerosol generation device. The aerosol generation device includes a power supply, a conversion circuit configured to convert power supplied from the power supply into high frequency power, a first magnetic body, and an induction coil that is wound around the first magnetic body and to which the high frequency power is supplied. In a state in which the stick is inserted into the cavity, a longitudinal direction of the first magnetic body and a longitudinal direction of the susceptor coincide with an insertion and extraction direction of the stick and the susceptor is positioned on an opening side when viewed from the induction coil.

### CROSS-REFERENCE TO RELATED APPLICATION

This is a continuation of International Application No. PCT/JP2021/042287 filed on Nov. 17, 2021, the entire content of which is incorporated herein by reference.

### TECHNICAL FIELD

The present disclosure relates to an aerosol generation system including a stick and an aerosol generation device.

### BACKGROUND ART

Aerosol generation devices using induction heating having an excellent heating efficiency have been known (JP2017-506915A, JP2021-065236A, JP6690862B, JP2019-526247A and JP2020-150959A). Such aerosol generation devices tend to have a larger size since more electronic components are needed in the induction heating than in the resistance heating. The aerosol generation devices disclosed in JP2017-506915A and JP2021-065236A generate aerosol by heating liquid and do not heat a stick including an aerosol source. In this regard, the aerosol generation devices disclosed in JP6690862B, JP2019-526247A and JP2020-150959A heat sticks including aerosol sources.

In the aerosol generation devices described in JP6690862B, JP2019-526247A and JP2020-150959A, since the susceptor and the induction coil wound around the ferromagnetic body are provided in the radial direction, the size of the aerosol generation device increases in the radial direction. Since the user grasps the aerosol generation device in the radial direction, it is important to prevent the aerosol generation device from becoming thick in the radial direction in order to improve the usability and the marketability of the aerosol generation device.

### SUMMARY

An aspect of the present disclosure relates to providing an aerosol generation system capable of heating an entire stick while preventing an aerosol generation device from becoming thick in the radial direction.

According to aspects of the present disclosure, there is provided an aerosol generation system including:
a stick including an aerosol source and a susceptor; and
an aerosol generation device,
in which a cavity into which the stick is configured to be inserted and extracted through an opening is formed,
the aerosol generation device includes
   a power supply,
   a conversion circuit configured to convert power supplied from the power supply into high frequency power,
   a cavity into which the stick is configured to be inserted and extracted through an opening,
   a first magnetic body, and
   an induction coil that is wound around the first magnetic body and to which the high frequency power is supplied, and
in a state in which the stick is inserted into the cavity, a longitudinal direction of the first magnetic body and a longitudinal direction of the susceptor coincide with an insertion and extraction direction of the stick and the susceptor is positioned on an opening side when viewed from the induction coil.

According to aspects of the present disclosure, it is possible to heat the entire stick while preventing the aerosol generation device from becoming thick in the radial direction.

### BRIEF DESCRIPTION OF DRAWINGS

FIG. 1 is a perspective view of a non-combustion inhalation device;

FIG. 2 is a perspective view of an aerosol generation system in which a stick is attached to the non-combustion inhalation device;

FIG. 3 is a block diagram showing the control configuration of the non-combustion inhalation device;

FIG. 4 is a cross-sectional view showing a stick and a heating unit according to a first embodiment;

FIG. 5 is a cross-sectional view of the stick according to the first embodiment;

FIG. 6 is a perspective view showing a second magnetic body and a susceptor that are accommodated in the stick, and a heating unit according to the first embodiment;

FIG. 7 is a cross-sectional view of a stick according to a second embodiment;

FIG. 8 is a cross-sectional view of a stick according to a third embodiment;

FIG. 9 is a cross-sectional view of a stick according to a fourth embodiment;

FIG. 10 is a cross-sectional view of a stick according to a fifth embodiment;

FIG. 11 is a cross-sectional view showing a stick and a heating unit according to a sixth embodiment;

FIG. 12 is a perspective view showing a second magnetic body and a susceptor that are accommodated in the stick, and the heating unit according to the sixth embodiment; and

FIG. 13 is an explanatory view showing the flow of the induction current in the susceptor according to the sixth embodiment.

### DESCRIPTION OF EMBODIMENTS

### (Aerosol Generation System)

Hereinafter, an aerosol generation system according to the present disclosure will be described with reference to the drawings. An aerosol generation system 1 includes a non-combustion inhalation device 100 (hereinafter, also simply referred to as “inhalation device 100”) which is an aerosol generation device, and a stick 500 heated by the inhalation device 100.

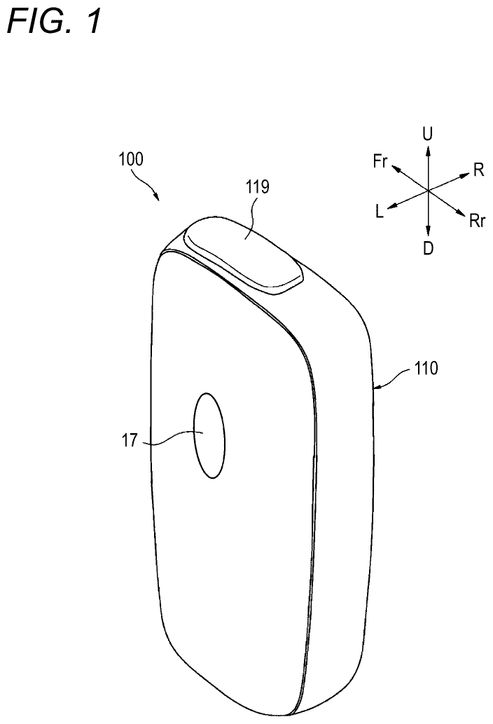

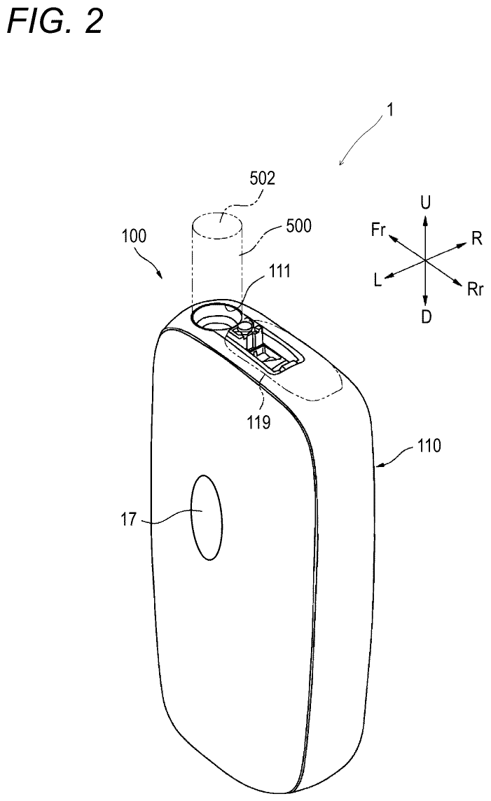

FIG. 1 is a perspective view showing an overall configuration of the inhalation device 100. FIG. 2 is a perspective view of the aerosol generation system 1 in which the stick 500 is attached to the inhalation device 100. In the following description, for convenience, the orthogonal coordinate system in the three-dimensional space will be described in which three directions orthogonal to one another are defined as a front-rear direction, a left-right direction, and an upper-lower direction. In the drawings, the front side is indicated by Fr, the rear side is indicated by Rr, the right side is indicated by R, the left side is indicated by L, the upper side is indicated by U, and the lower side is indicated by D.

As shown in FIGS. 1 and 2, the inhalation device 100 generates the aerosol containing a flavor by heating the stick 500 that is elongated and substantially columnar and that serves as an example of a flavor component generating base material including a filler or the like containing an aerosol source and a flavor source.

### (Overview of Stick)

The stick 500 includes a filler containing an aerosol source that generates the aerosol by being heated at a predetermined temperature. The type of the aerosol source is not particularly limited, and an extract substance from various natural products and/or a constituent component thereof may be selected according to the use. The aerosol source may be a solid, or may be, for example, a polyhydric alcohol such as glycerin or propylene glycol, or a liquid such as water. The aerosol source may include a flavor source such as a tobacco raw material that releases a flavor component by being heated, or an extract originated from a tobacco raw material. The gas to which the flavor component is added is not limited to the aerosol, and for example, invisible steam may be generated.

The filler of the stick 500 may contain cut tobacco as the flavor source. The material for the cut tobacco is not specifically limited, and the publicly known material such as a lamina and a stem may be used as the material. The filler may contain one type or two or more types of flavors. The types of flavors are not specifically limited, but in view of provision of the satisfactory smoke flavor, menthol is preferable. The flavor source may contain plants other than tobacco (for example, mints, herbal medicines, or herbs). Depending on the use, the stick 500 may not include the flavor source.

### (Overview of Non-Combustion Inhalation Device)

As shown in FIGS. 1 to 3, the inhalation device 100 includes a case 110, a power supply 10 provided in the internal space of the case 110, a control unit 120, and a heating unit 130. The case 110 has a substantially rectangular parallelepiped shape including a front surface, a rear surface, a left surface, a right surface, an upper surface, and a lower surface. The power supply 10 is a chargeable secondary battery, an electric double-layer capacitor, or the like, and is preferably a lithium ion secondary battery. The electrolyte of the power supply 10 may include one or a combination of a gel electrolyte, an electrolyte solution, a solid electrolyte, and an ionic liquid.

As shown in FIG. 2, the upper surface of the case 110 is formed with an opening 111 into which the stick 500 may be inserted, and a slider 119 that opens and closes the opening 111. The slider 119 is coupled to the case 110 in a manner of being movable in the front-rear direction between the position where the opening 111 is closed (see FIG. 1) and the position where the opening 111 is opened (see FIG. 2).

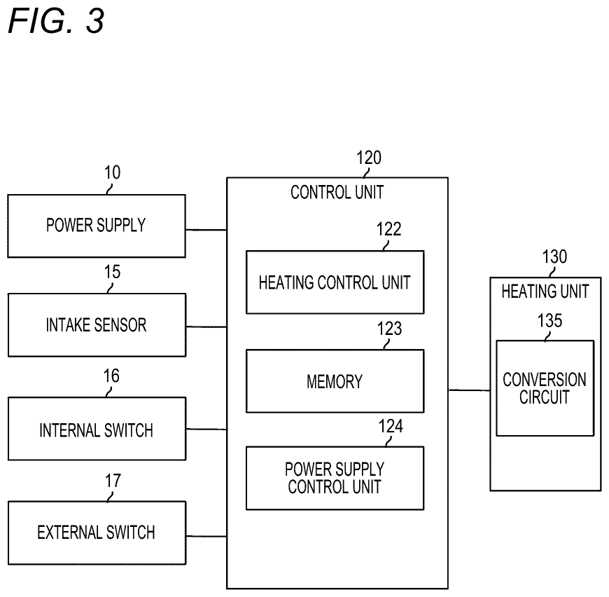

As shown in FIG. 3, the power supply 10, an intake sensor 15 that detects the puff (intake) operation, an internal switch 16 that detects insertion of the stick 500, and an external switch 17 that is provided outside the case 110 and that is to be operated by the user are connected to the input side of the control unit 120, and the heating unit 130 is connected to the output side of the control unit 120.

The inside of the control unit 120 includes, as the functional configurations implemented by cooperation of hardware and software, a heating control unit 122 that controls the heating unit 130 based on the switch signals of the internal switch 16 and the external switch 17, a memory 123 that stores the heating duration time of the heating unit 130, the number of times of the puff operation, and the like, and a power supply control unit 124 that manages charging and discharging of the power supply 10.

Specifically, the control unit 120 is a processor (a computer). More specifically, a structure of the processor is an electric circuit in which circuit elements such as a semiconductor device are combined. The intake sensor 15 may be implemented by a condenser microphone, a pressure sensor, or the like. Further, instead of detecting the puff by the intake sensor 15, the puff may be detected by sensing a temperature change of the heating unit 130 due to the puff using a thermistor.

The heating unit 130 heats the stick 500 inserted from the opening 111 without burning. When the stick 500 is heated, the aerosol is generated from the aerosol source contained in the stick 500, and the flavor of the flavor source contained in the stick 500 is added to the aerosol. The user may inhale the aerosol containing the flavor by holding in the mouth a suction port 502 of the stick 500 protruding from the opening 111 and perform suctioning.

### (Details of Heating Unit and Stick)

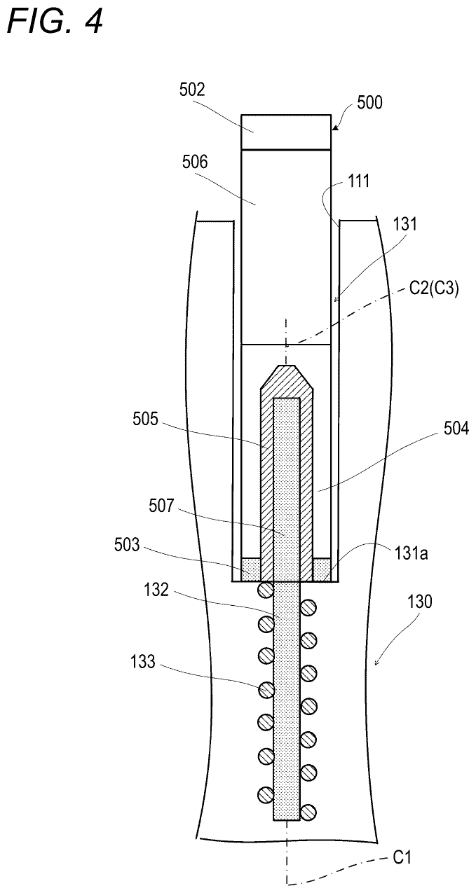

Next, the details of the heating unit 130 and the stick 500 will be described with reference to FIGS. 4 to 6. The heating unit 130 includes a conversion circuit 135 (see FIG. 3) that converts the power supplied from the power supply 10 into high frequency power, a cavity 131 through which the stick 500 may be inserted and extracted through the opening 111, a first magnetic body 132 made of a ferromagnetic body such as a ferrite core, and an induction coil 133 wound around the first magnetic body 132 and supplied with the high frequency power.

The stick 500 includes: a suction port 502 (a filter) located at the end portion on the opening 111 side, which is one side in the insertion and extraction direction, in the state in which the stick 500 is inserted into the cavity 131; a plug 503 located at the end portion on the induction coil 133 side, which is the other side in the insertion and extraction direction, and connected to a bottom surface portion 131a of the cavity 131; a susceptor 505 through which the induction current (the eddy current) flows due to the magnetic flux generated by the induction coil 133 of the suction device 100, and that converts the induction current into Joule heat (generates heat due to hysteresis loss); an aerosol source 504 provided around the susceptor 505; and a cooling flow path 506 that is located between the aerosol source 504 and the suction port 502 and that cools the aerosol. The aerosol source 504 according to the present embodiment includes a flavor source.

The heating unit 130 of the inhalation device 100 and the susceptor 505 of the stick 500 heat the aerosol source 504 by so-called induction heating. Most of the magnetic flux generated by the induction coil 133 reaches the susceptor 505 of the stick 500 and causes the susceptor 505 to generate the induction current. By using the first magnetic body 132 in the induction heating, the directivity of the magnetic flux generated by the induction coil 133 is improved by the first magnetic body 132, and the efficiency of the induction heating is improved as the magnetic flux density penetrating the susceptor 505 increases. Further, the first magnetic body 132 is magnetized by the magnetic flux generated by the induction coil 133 penetrating the first magnetic body 132, and the magnetic flux density penetrating the susceptor 505 also increases due to the magnetic flux emitted from the first magnetic body 132.

The first magnetic body 132 is a ferromagnetic member having a cylindrical shape whose cross section in the plane orthogonal to the longitudinal direction has a circular shape, and the induction coil 133 is wound around the outer peripheral side of the first magnetic body 132. The susceptor 505 is a conductive member whose cross section in the plane orthogonal to the longitudinal direction has a circular shape. The first magnetic body 132 and the susceptor 505 are not limited to having the cylindrical shape, and may be ferromagnetic members having a prismatic shape or a flat plate shape. In the state in which the stick 500 is inserted into the cavity 131, the longitudinal direction of the first magnetic body 132 and the longitudinal direction of the susceptor 505 coincide with the insertion and extraction direction of the stick 500, and the susceptor 505 is provided on the opening 111 side when viewed from the induction coil 133.

According to the heating unit 130 and the stick 500 implemented as described above, the induction coil 133 and the susceptor 505 are arranged in a line in the insertion and extraction direction of the stick 500. Therefore, it is possible to cause the magnetic flux amplified by the first magnetic body 132 to pass through the susceptor 505 while preventing the inhalation device 100 from becoming thicker in the radial direction. Accordingly, it is possible to heat the entire stick 500 while reducing the size of the inhalation device 100.

Since the cross section of the first magnetic body 132 in the plane orthogonal to the longitudinal direction has the circular shape, the magnetic field generated by the first magnetic body 132 and the induction coil 133 has the isotropic property. Accordingly, the heating efficiency of the stick 500 may be made constant with respect to the angle of the stick 500 in the rolling direction when the stick 500 is inserted into the cavity 131. The first magnetic body 132 is made of, for example, ferrite. The cross section of the first magnetic body 132 may not be a perfect circle or an ellipse, but may be a shape including a straight line in a part thereof.

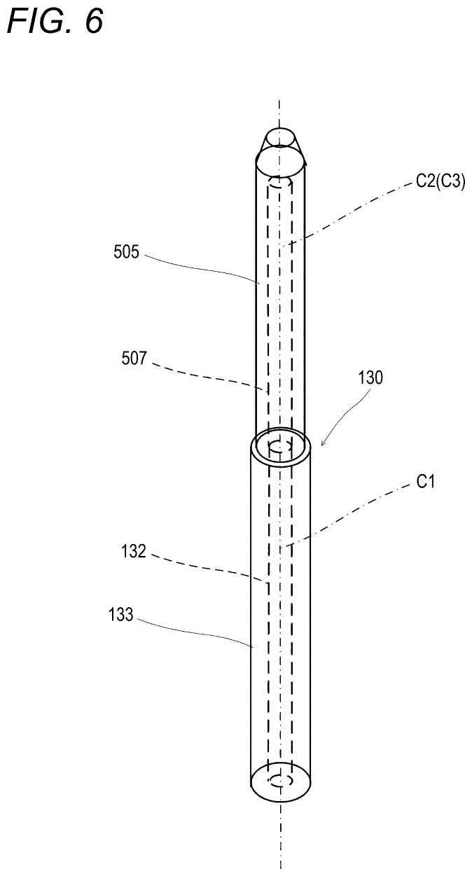

In the present embodiment, when the induction coil 133 and the susceptor 505 are arranged in a line in the insertion and extraction direction of the stick 500, as shown in FIGS. 4 and 6, a virtual line C2 obtained by extending a center line C1 of the induction coil 133 toward the opening 111 overlaps a center line C3 of the susceptor 505. In this way, the magnetic flux generated by the induction coil 133 and the first magnetic body 132 may easily pass through the center of the susceptor 505, and a large amount of magnetic flux may pass through the susceptor 505.

As shown in FIGS. 4 to 6, the stick 500 includes a second magnetic body 507 provided inside the susceptor 505 such that the longitudinal direction of the second magnetic body 507 coincides with the insertion and extraction direction of the stick 500. The second magnetic body 507 according to the present embodiment is a ferromagnetic member having a cylindrical shape whose cross section in the plane orthogonal to the longitudinal direction has a circular shape, and is arranged in a line in the insertion and extraction direction of the first magnetic body 132 and the stick 500 in the state in which the stick 500 is inserted into the cavity 131. The second magnetic body 507 is made of, for example, ferrite. The cross section of the second magnetic body 507 may not be a perfect circle or an ellipse, but may be a shape including a straight line in a part thereof.

When such a second magnetic body 507 is provided, more magnetic flux may be delivered to the susceptor 505 via the second magnetic body 507, and thus the heating efficiency of the stick 500 may be improved. That is, the first magnetic body 132 and the second magnetic body 507 are magnetized by the magnetic flux generated by the induction coil 133 penetrating the first magnetic body 132 and the second magnetic body 507, and the magnetic flux density penetrating the susceptor 505 also increases due to the magnetic flux emitted from the first magnetic body 132 and the second magnetic body 507. Since the cross sections of the first magnetic body 132 and the second magnetic body 507 in the plane orthogonal to the longitudinal direction have the circular shape, the magnetic field generated by the first magnetic body 132, the second magnetic body 507, and the induction coil 133 has the isotropic property. Accordingly, the heating efficiency of the stick 500 may be made constant with respect to the angle of the stick 500 in the rolling direction when the stick 500 is inserted into the cavity 131. The second magnetic body 507 is also not limited to having the cylindrical shape, and may be ferromagnetic members having a prismatic shape or a flat plate shape.

The cross-sectional area of the second magnetic body 507 in a plane orthogonal to the longitudinal direction of the second magnetic body 507 is preferably equal to or larger than the cross-sectional area of the first magnetic body 132 in a plane orthogonal to the longitudinal direction of the first magnetic body 132. In this way, since most of the magnetic flux generated by the first magnetic body 132 and the induction coil 133 may be delivered to the susceptor 505, the heating efficiency of the stick 500 may be improved.

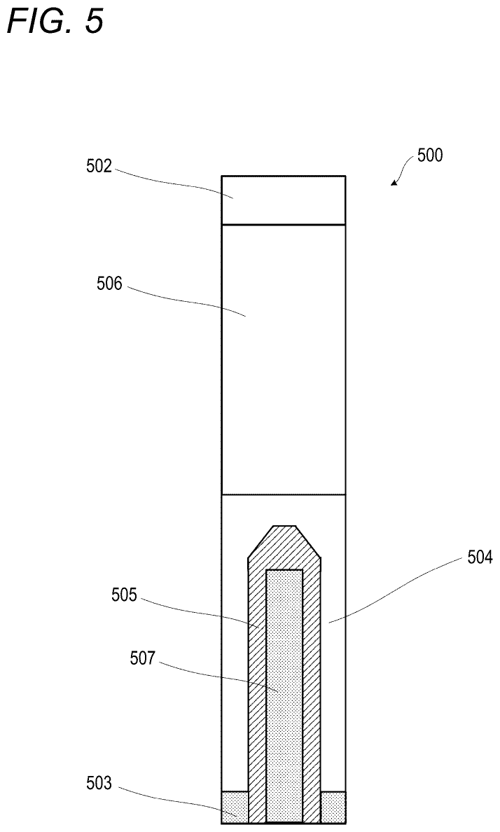

In the second magnetic body 507, the end portion (hereinafter, may be referred to as the other end portion) on the induction coil 133 side extends to the plug 503. For example, as shown in FIGS. 4 and 5, the other end portion of the second magnetic body 507 penetrates the plug 503 and extends to the other end of the stick 500. In this way, as compared to the case in which the second magnetic body 507 does not extend to the plug 503, it becomes less likely to leave space between the first magnetic body and the second magnetic body. Accordingly, a large amount of magnetic flux may be delivered to the susceptor 505. In the present disclosure, “A extends to B” means that at least a part of A overlaps B in the insertion and extraction direction of the stick 500, and “A does not extend to B” means that A does not overlap B in the insertion and extraction direction. It should be noted that “A does not extend to B” includes that the end portion of A abuts against the end portion of B.

As shown in FIGS. 4 and 5, in the susceptor 505, similarly to the second magnetic body 507, the end portion (hereinafter, may be referred to as the other end portion) on the induction coil 133 side extends to the plug 503, and further extends to the other end of the stick 500 through the plug 503. In this way, as compared with the case in which the susceptor 505 is not extended to the plug 503, the leakage flux may be reduced, and thus the heating efficiency of the stick 500 may be improved.

### Second Embodiment

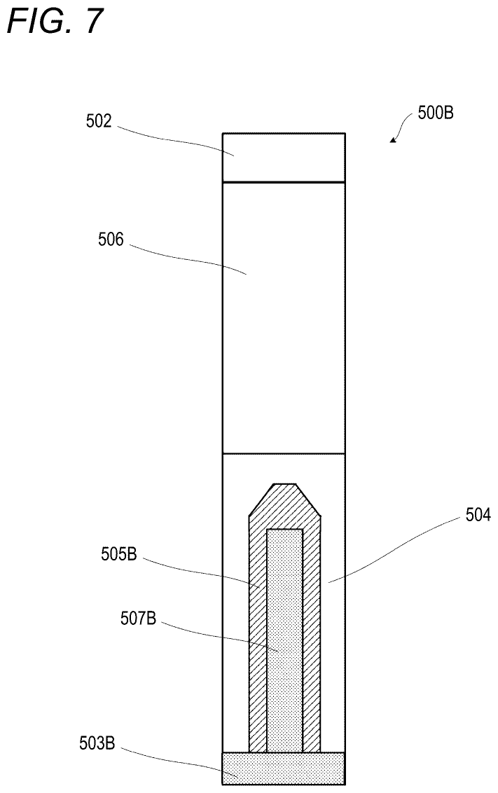

Next, sticks 500B to 500F according to the second to sixth embodiments will be described with reference to FIGS. 7 to 13. However, for the configurations common to those according to the above embodiment, the same reference signs as those in the above embodiment are used, and the description of the above embodiment may be referred to.

As shown in FIG. 7, the stick 500B according to the second embodiment is different from the first embodiment in that the other end portion of a susceptor 505B and the other end portion of a second magnetic body 507B do not extend to a plug 503B. That is, in the stick 500B, the other end portion of the susceptor 505B and the other end portion of the second magnetic body 507B abut against the plug 503B, and the plug 503B covers the other end portion of the susceptor 505B and the other end portion of the second magnetic body 507B.

According to such a second embodiment, the susceptor 505B does not heat the plug 503B that does not contribute to aerosol generation, so that the portion (the aerosol source 504) that contributes to aerosol generation may be heated in a concentrated manner, and thus the aerosol generation efficiency may be improved. The plug 503B may prevent the susceptor 505B and the second magnetic body 507B from falling off the stick 500B.

### Third Embodiment

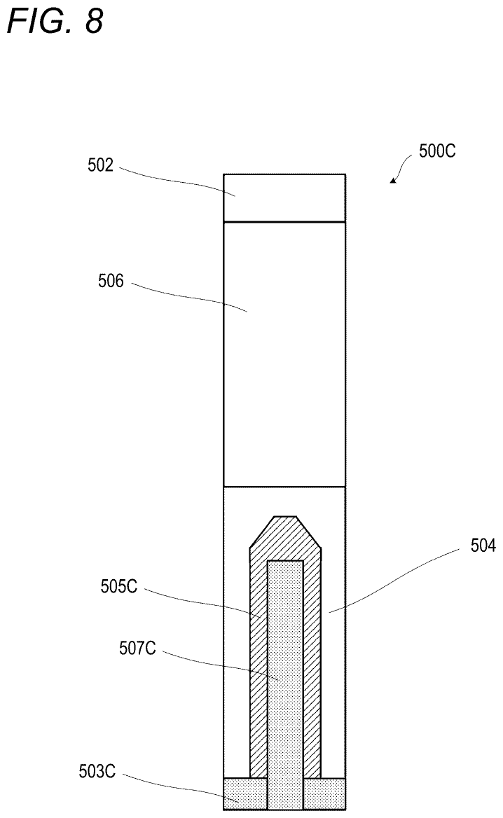

As shown in FIG. 8, the stick 500C according to the third embodiment is different from the first embodiment in that the other end portion of a susceptor 505C does not extend to a plug 503C, and is different from the second embodiment in that the other end portion of a second magnetic body 507C extends to the plug 503C. That is, in the stick 500C, the other end portion of the susceptor 505C abuts against the plug 503C, and the plug 503C covers the other end portion of the susceptor 505C. The other end portion of the second magnetic body 507C extends to the plug 503C and further extends to the other end of the stick 500 through the plug 503C.

According to such a third embodiment, the susceptor 505C does not heat the plug 503C that does not contribute to aerosol generation, so that the portion (the aerosol source 504) that contributes to aerosol generation may be heated in a concentrated manner, and thus the aerosol generation efficiency may be improved. As compared to the case in which the second magnetic body 507C does not extend to the plug 503C, more magnetic flux may be delivered from the first magnetic body 132 to the susceptor 505B via the second magnetic body 507C. The plug 503C may prevent the susceptor 505C from falling off the stick 500C.

### Fourth Embodiment

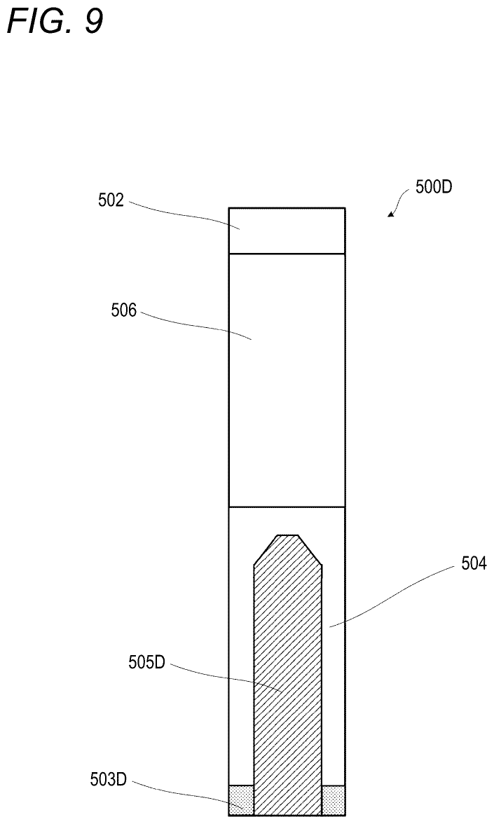

As shown in FIG. 9, the stick 500D according to the fourth embodiment is different from the first to third embodiments in that no magnetic body is provided inside a susceptor 505D. That is, in the stick 500D, only the other end portion of the susceptor 505D extends to a plug 503D, and further extends to the other end of the stick 500 through the plug 503D.

According to such a fourth embodiment, since the structure of the stick 500D is simpler than when a magnetic body is provided inside the susceptor 505D, the cost of the stick 500D may be reduced. Since the susceptor 505D extends to the plug 503D, more magnetic flux may be delivered from the first magnetic body 132 to the susceptor 505B as compared with the case in which the susceptor 505D is not extended to the plug 503D. Therefore, the leakage flux may be reduced and the heating efficiency of the stick 500D may be improved.

### Fifth Embodiment

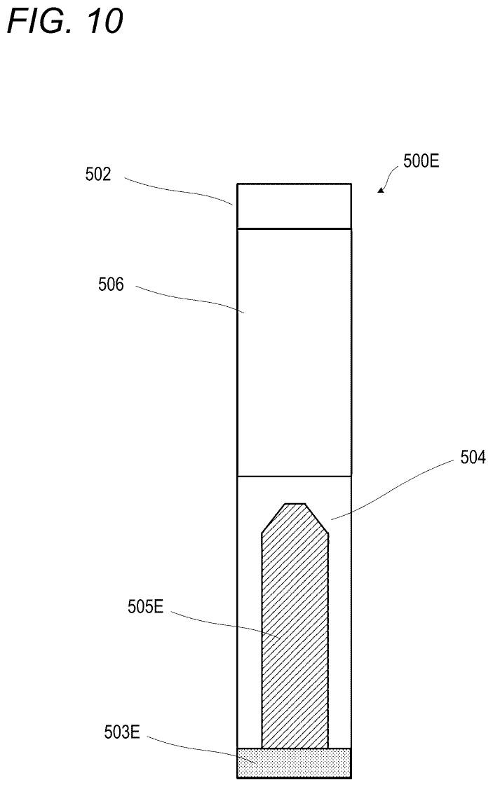

As shown in FIG. 10, the stick 500E according to the fifth embodiment is different from the first to third embodiments in that no magnetic body is provided inside a susceptor 505E, and is different from the fourth embodiment in that the susceptor 505E does not extend to a plug 503E. That is, in the stick 500E, only the other end portion of the susceptor 505E abuts against the plug 503E, and the plug 503E covers the other end portion of the susceptor 505E.

According to such a fifth embodiment, since the structure of the stick 500E is simpler than when a magnetic body is provided inside the susceptor 505E, the cost of the stick 500E may be reduced. The susceptor 505E does not heat the plug 503E that does not contribute to aerosol generation, so that the portion (the aerosol source 504) that contributes to aerosol generation may be heated in a concentrated manner, and thus the aerosol generation efficiency may be improved. The plug 503E may prevent the susceptor 505E from falling off the stick 500E.

### Sixth Embodiment

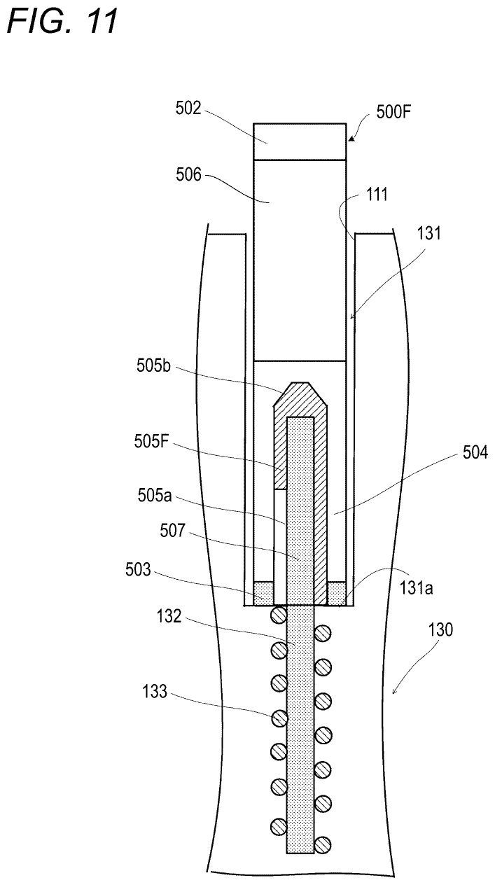

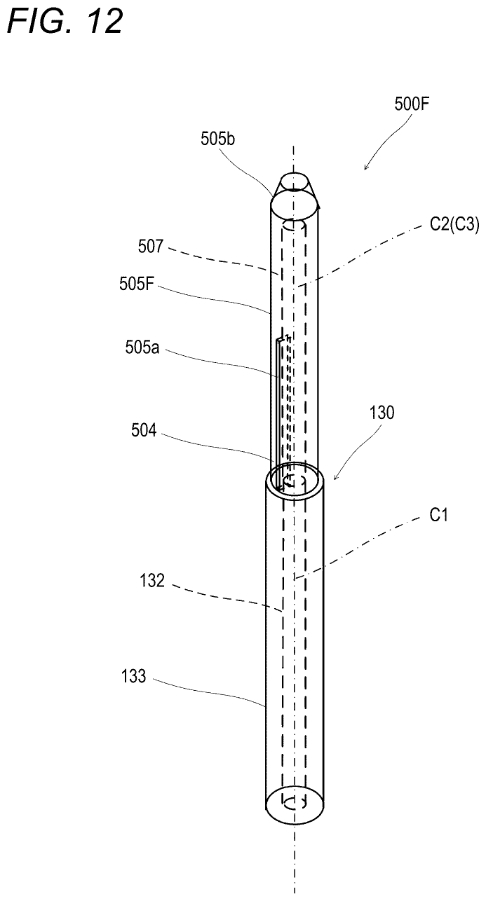

As shown in FIGS. 11 and 12, the stick 500F according to the sixth embodiment is different from the first embodiment in that a susceptor 505F has a slit 505a extending in the longitudinal direction (the insertion and extraction direction of the stick 500F). In the first embodiment, the magnetic flux density penetrating the susceptor 505 increases due to the first magnetic body 132 and the second magnetic body 507. Alternatively, the magnetic flux density may still decrease in the susceptor 505 from the side close to the induction coil 133 toward the side far away from the induction coil 133. When such a bias in magnetic flux density occurs, the induction current is concentrated near the root of the susceptor 505 close to the induction coil 133, and the temperature gradient occurs in the susceptor 505 in which the temperature is high near the root of the susceptor 505 and the temperature decreases as the distance from the induction coil 133 increases. When the temperature gradient occurs in the susceptor 505, the stick 500 cannot be uniformly heated, and the aerosol generation efficiency may deteriorate.

In the present embodiment, the slit 505a extending in the longitudinal direction is formed in the susceptor 505F. Accordingly, the flow of the induction current in the susceptor 505F may be improved by the slit 505a, and the temperature gradient that is likely to occur in the longitudinal direction of the susceptor 505F may be reduced.

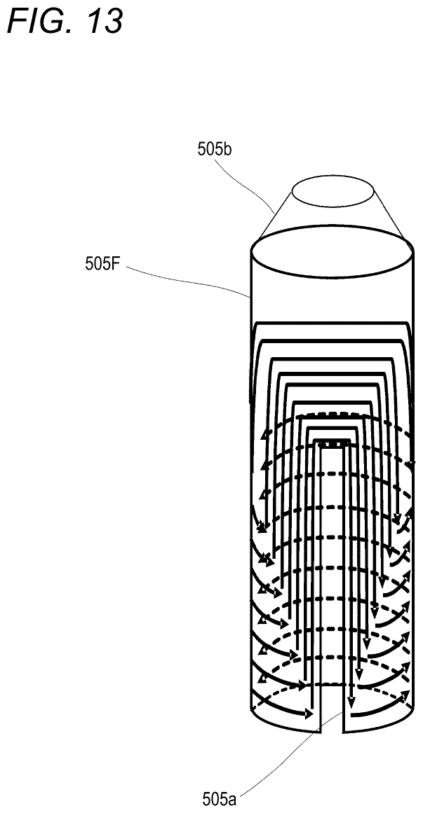

The susceptor 505F has a protrusion 505b at the end portion on the opening 111 side. Preferably, the slit 505a does not extend to the protrusion 505b. The slit 505a is preferably formed such that the end portion on the induction coil 133 side extends to the end portion of the susceptor 505F on the induction coil 133 side. In this way, as shown in FIG. 13, the induction current that is likely to concentrate on the induction coil 133 side of the susceptor 505F flows around the opening 111 side to bypass the slit 505a. Accordingly, the induction current may flow from the root side to the distal end side of the susceptor 505F, and the temperature gradient of the susceptor 505 may be further reduced. The case has been illustrated in which the susceptor 505F has the protrusion 505b. However, the susceptor 505F does not necessarily need to have the protrusion 505b. In this case, preferably, the slit 505a does not extend to the end portion on the opening 111 side. The length of the slit 505a is preferably ¾ or less, or ½ or less of the total length in the longitudinal direction.

An insulating member (not shown) may be provided in the slit 505a. In other words, the slit 505a may be filled with an insulating member. As a specific example, epoxy resin may be used for this insulating member. In this way, since entry of foreign objects from the slit 505a may be prevented, the durability of the suction device 100 may be improved. In the example shown in FIGS. 11 to 13, the slit 505a is formed at only one location in the circumferential direction. Alternatively, the slit 505a may be formed at two or more locations. Further, the slit 505a may also be applied to the susceptors 505B to 505E according to the second to fifth embodiments. Ceramic or glass having better heat resistance than epoxy resin may be used for the insulating member.

Although various embodiments have been described above with reference to the drawings, it is needless to say that the present disclosure is not limited to these examples. It is apparent to a person skilled in the art that various changes and modifications may be conceived within the scope described in the claims, and it is understood that the changes and the modifications naturally fall within the technical scope of the present disclosure. In addition, the components described in the above embodiments may be freely combined without departing from the spirit of the disclosure.

In the present specification, at least the following matters are described. In parentheses, corresponding components and the like in the above embodiment are shown, but the present disclosure is not limited thereto.

(1) An aerosol generation system (aerosol generation system 1) including:
a stick (stick 500 to 500F) including an aerosol source (aerosol source 504) and a susceptor (susceptor 505-505F); and
an aerosol generation device (non-combustion inhalation device 100),
in which a cavity (cavity 131) into which the stick is configured to be inserted and extracted through an opening is formed in the aerosol generation device,
the aerosol generation device includes
   a power supply (power supply 10),
   a conversion circuit (conversion circuit 135) configured to convert power supplied from the power supply into high frequency power,
   a first magnetic body (first magnetic body 132), and
   an induction coil (induction coil 133) that is wound around the first magnetic body and to which the high frequency power is supplied, and
in a state in which the stick is inserted into the cavity, a longitudinal direction of the first magnetic body and a longitudinal direction of the susceptor coincide with an insertion and extraction direction of the stick and the susceptor is positioned on an opening side when viewed from the induction coil.

According to (1), by arranging the first magnetic body and the susceptor in a line in the insertion and extraction direction such that the longitudinal directions of the first magnetic body and the susceptor coincide with the insertion and extraction direction of the stick, it is possible to cause the magnetic flux amplified by the first magnetic body to pass through the susceptor while preventing the aerosol generation device from becoming thick in the radial direction. Accordingly, it is possible to heat the entire stick while reducing the size of the aerosol generation device.

(2) The aerosol generation system according to (1),
in which a cross section of the first magnetic body in a plane orthogonal to the longitudinal direction of the first magnetic body has a circular shape.

According to (2), since the magnetic field generated by the first magnetic body and the induction coil has the isotropic property, the heating efficiency of the stick may be made constant with respect to the angle of the stick in the rolling direction when the stick is inserted into the cavity.

(3) The aerosol generation system according to (1),
in which the stick includes a second magnetic body (second magnetic body 507 to 507C) at least partially located inside the susceptor.

According to (3), since more magnetic flux may be delivered to the susceptor, the heating efficiency of the stick may be improved.

(4) The aerosol generation system according to (3),
in which a cross section of the first magnetic body in a plane orthogonal to the longitudinal direction of the first magnetic body has a circular shape, and
a cross section of the second magnetic body in a plane orthogonal to a longitudinal direction of the second magnetic body has a circular shape.

According to (4), since the magnetic field generated by the first magnetic body, the second magnetic body, and the induction coil has the isotropic property, the heating efficiency of the stick may be made constant with respect to the angle of the stick in the rolling direction when the stick is inserted into the cavity.

(5) The aerosol generation system according to (4),
in which a cross-sectional area of the second magnetic body on the plane orthogonal to the longitudinal direction of the second magnetic body is equal to or larger than a cross-sectional area of the first magnetic body on the plane orthogonal to the longitudinal direction of the first magnetic body.

According to (5), since most of the magnetic flux generated by the first magnetic body and the induction coil may be delivered to the susceptor, the heating efficiency of the stick may be improved.

(6) The aerosol generation system according to any one of (3) to (5),
in which the stick includes a suction port (suction port 502) located on the opening side and a plug (plug 503) located on a side opposite to the opening side in the insertion and extraction direction of the stick, and
the second magnetic body extends to the plug.

According to (6), as compared to the case in which the second magnetic body does not extend to the plug, it becomes less likely to leave space between the first magnetic body and the second magnetic body. Accordingly, since more magnetic flux may be delivered to the susceptor, the heating efficiency of the stick may be improved.

(7) The aerosol generation system according to (6),
in which the susceptor extends to the plug.

According to (7), as compared with the case in which the susceptor is not extended to the plug, the leakage flux may be reduced, and thus the heating efficiency of the stick may be improved.

(8) The aerosol generation system according to (6),
in which the susceptor does not extend to the plug.

According to (8), the plug that does not contribute to aerosol generation is not heated, so that the portion that contributes to aerosol generation may be heated in a concentrated manner, and thus the aerosol generation efficiency may be improved. The susceptor may be prevented from falling off.

(9) The aerosol generation system according to (1) or (2),
in which the stick does not include a magnetic body inside the susceptor.

According to (9), since the structure of the stick is simpler than when a magnetic body is provided inside the susceptor, the cost of the stick may be reduced.

(10) The aerosol generation system according to (9),
in which the stick includes a suction port (suction port 502) located on the opening side and a plug (plug 503) located on a side opposite to the opening side in the insertion and extraction direction of the stick, and
the susceptor extends to the plug.

According to (10), as compared with the case in which the susceptor is not extended to the plug, the leakage flux may be reduced, and thus the heating efficiency of the stick may be improved.

(11) The aerosol generation system according to (9),
in which the stick includes a suction port (suction port 502) located on the opening side and a plug (plug 503) located on a side opposite to the opening side in the insertion and extraction direction of the stick, and
the susceptor does not extend to the plug.

According to (11), the plug that does not contribute to aerosol generation is not heated, so that the portion that contributes to aerosol generation may be heated in a concentrated manner, and thus the aerosol generation efficiency may be improved. The susceptor may be prevented from falling off.

(12) The aerosol generation system according to any one of (1) to (11),
in which the susceptor has a gap (slit 505a) extending in the longitudinal direction.

According to (12), the flow of the induction current in the susceptor may be improved by the gap, and thus the entire stick may be heated.

(13) The aerosol generation system according to (12),
in which the susceptor has a protrusion (protrusion 505b) at an end portion on the opening side, and
the gap does not extend to the protrusion.

According to (13), the induction current that is likely to concentrate near the root of the susceptor may flow to other portions of the susceptor, and thus the entire stick may be heated.

(14) The aerosol generation system according to (12) or (13),
in which the gap extends to an end portion on a side opposite to the opening side.

According to (14), the induction current that is likely to concentrate near the root of the susceptor may flow to other portions of the susceptor, and thus the entire stick may be heated.

(15) The aerosol generation system according to any one of (12) to (14),
in which an insulating member is provided at at least a part of the gap.

According to (15), since entry of foreign objects from the slit may be prevented, the durability of the aerosol generation device is improved and the operation thereof is stabilized.

What is claimed is:

1. An aerosol generation system comprising:
a stick including an aerosol source and a susceptor; and
an aerosol generation device,
wherein a cavity into which the stick is configured to be inserted and extracted through an opening is formed in the aerosol generation device,
wherein the aerosol generation device includes
a power supply,
a conversion circuit configured to convert power supplied from the power supply into high frequency power,
a first magnetic body, and
an induction coil that is wound around the first magnetic body and to which the high frequency power is supplied, and
wherein, in a state in which the stick is inserted into the cavity, a longitudinal direction of the first magnetic body and a longitudinal direction of the susceptor coincide with an insertion and extraction direction of the stick and the susceptor is positioned on an opening side when viewed from the induction coil.

2. The aerosol generation system according to claim 1,
wherein a cross section of the first magnetic body in a plane orthogonal to the longitudinal direction of the first magnetic body has a circular shape.

3. The aerosol generation system according to claim 1,
wherein the stick includes a second magnetic body at least partially located inside the susceptor.

4. The aerosol generation system according to claim 3,
wherein a cross section of the first magnetic body in a plane orthogonal to the longitudinal direction of the first magnetic body has a circular shape, and
wherein a cross section of the second magnetic body in a plane orthogonal to a longitudinal direction of the second magnetic body has a circular shape.

5. The aerosol generation system according to claim 4,
wherein a cross-sectional area of the second magnetic body on the plane orthogonal to the longitudinal direction of the second magnetic body is equal to or larger than a cross-sectional area of the first magnetic body on the plane orthogonal to the longitudinal direction of the first magnetic body.

6. The aerosol generation system according to claim 3,
wherein the stick includes a suction port located on the opening side and a plug located on a side opposite to the opening side in the insertion and extraction direction of the stick, and
wherein the second magnetic body extends to the plug.

7. The aerosol generation system according to claim 6,
wherein the susceptor extends to the plug.

8. The aerosol generation system according to claim 6,
wherein the susceptor does not extend to the plug.

9. The aerosol generation system according to claim 1,
wherein the stick does not include a magnetic body inside the susceptor.

10. The aerosol generation system according to claim 9,
wherein the stick includes a suction port located on the opening side and a plug located on a side opposite to the opening side in the insertion and extraction direction of the stick, and
wherein the susceptor extends to the plug.

11. The aerosol generation system according to claim 9,
wherein the stick includes a suction port located on the opening side and a plug located on a side opposite to the opening side in the insertion and extraction direction of the stick, and
wherein the susceptor does not extend to the plug.

12. The aerosol generation system according to claim 1,
wherein the susceptor has a gap extending in the longitudinal direction.

13. The aerosol generation system according to claim 12,
wherein the susceptor has a protrusion at an end portion on the opening side, and
wherein the gap does not extend to the protrusion.

14. The aerosol generation system according to claim 12,
wherein the gap extends to an end portion on a side opposite to the opening side.

15. The aerosol generation system according to claim 12,
wherein an insulating member is provided at at least a part of the gap.
